(19) United States
(12) Patent Application Publication
(10) Pub. No.: US 2015/0073810 A1
(43) Pub. Date: Mar. 12, 2015

(54) MUSIC PLAYING METHOD AND MUSIC PLAYING SYSTEM

(71) Applicant: MEDIASEEK, inc., Tokyo (JP)

(72) Inventors: Naoki Nishio, Tokyo (JP); Yasuhiro Nezu, Tokyo (JP); Eiichi Osawa, Tokyo (JP)

(21) Appl. No.: 14/534,186

(22) Filed: Nov. 6, 2014

Related U.S. Application Data
(63) Continuation of application No. PCT/JP2012/067354, filed on Jul. 6, 2012.

(51) Int. Cl. G06F 17/30; G10L 17/22

(52) U.S. Cl. CPC G06F 17/30746; G10L 17/22
USPC 704/275

(57) ABSTRACT

The music playing method comprises acquiring an inputted voice, detecting that any one registered character string from among a plurality of registered character strings stored in a recording medium is contained in the voice, and outputting music corresponding to the registered character string after a delay time stored in the recording medium has passed from the time when the voice containing the registered character string is detected in the character string detecting.

### CROSS-REFERENCE TO RELATED APPLICATIONS

The present application is a continuation application of International Application number PCT/JP2012/67354, filed on Jul. 6, 2012. The content of this application is incorporated herein by reference in their entirety.

### BACKGROUND OF THE INVENTION

The present disclosure relates to a music playing method, a music playing system, and a recording medium storing a music playing program for playing music in response to a voice of a user.

Conventionally, a music data playing apparatus for retrieving music data that a user likes from among the music data recorded in a hard disk or the like is known. When a voice inputted by the user includes a keyword for retrieving a music title or an artist name, for example, a conventional music data playing apparatus plays music corresponding to the keyword (see Japanese Unexamined Patent Application Publications No. 2003-84783 and No. H11-95790).

Further, an apparatus which acquires the music data of sound effects, background music (BGM), and the like associated with a detection result of the voice inputted by the user during a call through a communication line, and transmits a sound generated by synthesizing the inputted voice and the music data to a person at the other end of the line is also known (see Japanese Unexamined Patent Application Publication No. 2007-251581).

However, the conventional music data playing apparatus has a problem that a period of time required for playing the music after the user inputs the voice changes depending on content of the voice inputted by the user and the time required for retrieving a desired music from the database storing the music data. The conventional music data playing apparatus plays music so that a user who inputs his/her voice listens to the music or sings at karaoke. Accordingly, there was no need to consider an effect of variations of the period of time from the time when the voice is inputted until the time when the music starts to be played.

However, there is a problem that the effect of playing the music is reduced if the period of time from the time when the voice is inputted until the time when the music is played varies in a case where music suitable for a particular word spoken during a conversation is played to enhance a mood, or music is played in response to a word spoken during a presentation.

For example, when music for celebrating a birthday is played after a phrase “happy birthday” is spoken, if the music is played 0.1 seconds after the phrase “happy birthday” is spoken, the timing of playing the music is too early and the atmosphere becomes restless. If the music is played 5 seconds after the phrase “happy birthday,” the timing of playing the music is too late and the mood is broken.

Further, there was a problem that it was difficult to make an effective presentation in which the speaker wants to play desired music following a word that the speaker speaks during the presentation, if the period of time before the music is played cannot be estimated, because an unexpected moment of silence is made or the music starts just at the moment the speaker begins to speak.

### BRIEF SUMMARY OF THE INVENTION

Therefore, in one aspect of the innovation included herein, a music playing method, a music playing system, and a recording medium storing a music playing program for playing the music in a suitable timing in response to the voice inputted by the user are provided.

In the first aspect of the present disclosure, a music playing method for playing music using a computer, the method comprises acquiring an inputted voice, detecting that any one of a plurality of registered character strings stored in a memory is contained in the voice, and outputting music corresponding to the registered character string after a delay time stored in the memory has passed from the time when the voice containing the registered character string detected in the detecting is acquired is provided.

In the second aspect of the present disclosure, a music playing system for playing music comprises a computer, and a data managing apparatus configured to transmit and receive data to and from the computer, wherein the computer includes a voice acquiring part configured to acquire an inputted voice, a character string storage part configured to store a plurality of registered character strings, a character string detecting part configured to detect that any one of the plurality of registered character strings is contained in the voice, and a character string transmitting part configured to transmit the registered character string detected by the character string detecting part to the data managing apparatus, the data managing apparatus includes a music data storage part configured to store the plurality of registered character strings and a plurality of pieces of music data in association with each other, and a music data transmitting part configured to transmit the music data corresponding to the registered character string received from the computer to the computer, and the computer further includes a delay time storage part configured to store information showing the delay time from the time when the voice is acquired to the time when music based on the music data is outputted, and an outputting part configured to output the music after the delay time has passed from the time when the voice is acquired is provided.

In the third aspect of the present disclosure, a non-transitory recording medium storing a music playing program that causes a computer to perform acquiring the inputted voice, detecting that any one of the plurality of registered character strings stored in a memory is contained in the voice, and outputting music corresponding to the registered character string after a delay time stored in the memory has passed from the time when the voice containing the registered character string detected in the detecting is acquired is provided.

### BRIEF DESCRIPTION OF THE DRAWINGS

FIG. 1 shows a configuration of a computer according to the first exemplary embodiment.

FIG. 2 shows the configuration of an information terminal which is an example of the computer according to the first exemplary embodiment.

FIG. 3 shows an example of a flow chart of a music playing method according to the first exemplary embodiment.

FIG. 4 shows another configuration example of the computer executing the music playing method according to the first exemplary embodiment.

FIG. 5 shows an example of the flow chart of registering music in the music playing method according to the first exemplary embodiment.

FIG. 6 shows a configuration example of a music data package according to the first exemplary embodiment.

FIG. 7 shows another configuration example of the computer executing the music playing method according to the first exemplary embodiment.

FIG. 8 shows an example of the flow chart of registering music in the music playing method according to the first exemplary embodiment.

FIG. 9 shows another example of the flow chart of registering music in the music playing method according to the first exemplary embodiment.

FIG. 10 shows another example of the flow chart of registering music in the music playing method according to the first exemplary embodiment.

FIG. 11 shows an example of a communication sequence of registering music in the music playing method according to the first exemplary embodiment.

FIG. 12 shows the configuration example of a music playing system which consists of a plurality of computers executing the music playing method according to the second exemplary embodiment.

FIG. 13 shows a configuration example of the music playing system according to the third exemplary embodiment.

### DETAILED DESCRIPTION OF THE INVENTION

Hereinafter, the present disclosure is described through embodiments of the present disclosure. The following embodiments do not limit the claimed inventions, and all of the combinations of the features that are described in the embodiments are not always essential for the means for solving the problems of the disclosure.

### The First Exemplary Embodiment

### A Basic Configuration of a Music Playing Method

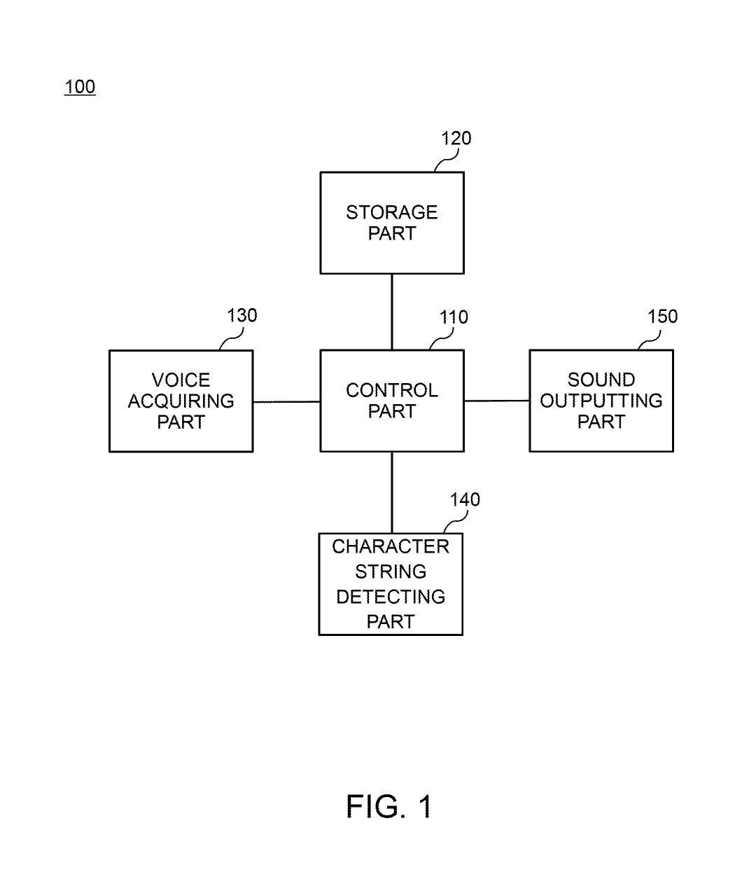

FIG. 1 shows a configuration of a computer 100 executing a music playing method according to the first exemplary embodiment. The computer 100 includes a control part 110, a storage part 120, a voice acquiring part 130, a character string detecting part 140, and a sound outputting part 150.

The control part 110 is, for example, a microprocessor executing a music playing program. The control part 110 controls the storage part 120, the voice acquiring part 130, the character string detecting part 140, and the sound outputting part 150 by executing the music playing program.

The storage part 120 stores data under the control of the control part 110. The storage part 120 may be a nonvolatile memory or a volatile memory. The storage part 120 may be a recording medium such as a removable memory card or a CD-ROM. The storage part 120 stores the music playing program. The control part 110 may execute the music playing program stored in the storage part 120 or execute the music playing program downloaded from a server and the like through a network.

The voice acquiring part 130 acquires the voice inputted by the user. For example, the voice acquiring part 130 includes a microphone. The control part 110 converts the voice acquired by the voice acquiring part 130 into a digital signal and stores the signal in the storage part 120. The control part 110 stores the time when the voice acquiring part 130 acquires the voice in the storage part 120 in association with the voice. For example, the control part 110 stores the time when the voice acquiring part 130 acquires the voice in the storage part 120 in association with each piece of voice data which is converted into the digital signal.

The character string detecting part 140 detects that any one of a plurality of registered character strings previously stored in the storage part 120 is contained in the voice acquired by the voice acquiring part 130. For example, the character string detecting part 140 converts the voice into a character string by using voice recognition technology and then retrieves the registered character string from the converted character string. Specifically, the character string detecting part 140 compares a signal pattern of the voice acquired by the voice acquiring part 130 (hereinafter referred to as an “inputted voice pattern”) with a plurality of signal patterns of the voices corresponding to a plurality of registered character strings stored in the storage part 120 (hereinafter referred to as “registered voice patterns”). When a degree of similarity between a registered voice pattern A and the inputted voice pattern is larger than a threshold value, the character string detecting part 140 may detect that the registered character string corresponding to the registered voice pattern A is contained in the voice acquired by the voice acquiring part 130.

The sound outputting part 150 outputs the music corresponding to the detected registered character string after a delay time stored in the storage part 120 passes after the voice acquiring part 130 acquires the voice in which the character string detecting part 140 detected the registered character string.

For example, the sound outputting part 150 outputs the music previously stored in the storage part 120 in association with the registered character string.
The sound outputting part 150 may output the music after acquiring the music corresponding to a music name previously stored in the storage part 120 in association with the registered character string from the server which is connected through the network such as the Internet.

For example, the sound outputting part 150 outputs the music after the delay time which is longer than the maximum period of time required for the character string detecting part 140 to detect the registered character string passes after the voice acquiring part 130 acquires the voice in which the character string detecting part 140 detected the registered character string. The sound outputting part 150 may output the music after the delay time which is longer than the sum of (i) the maximum period of time required for the character string detecting part 140 to detect the registered character string and (ii) the maximum period of time required for preparing the music corresponding to the registered character string to be played passes after the voice in which the registered character string was detected is acquired.

The sound outputting part 150 may read the time when the voice acquiring part 130 acquires the voice in which the character string detecting part 140 detected the registered character string from the storage part 120, and output the music at the time obtained by adding the maximum period of time required for the character string detecting part 140 to detect the registered character string to the read time. The sound outputting part 150 may output the music at the time obtained by adding, to the time read from the storage part 120, (i) the maximum period of time required for the character string detecting part 140 to detect the registered character string and (ii) the maximum period of time for the music corresponding to the registered character string to be acquired.

The sound outputting part 150 may output the music after the delay time passes from the time when the voice corresponding to the beginning of the registered character string is acquired, or output the music after the delay time passes from the time when the voice corresponding to the end of the registered character string is acquired. The sound outputting part 150 may determine whether the time of a starting point of the delay time for outputting the music is the time when the beginning of the registered character is acquired or the time when the end of the registered character is acquired according to the length of the registered character string. For example, the sound outputting part 150 sets the starting point at the beginning of the registered character string for a registered character string whose length is shorter than a predetermined length, and sets the starting point at the end of the registered character string for a registered character string whose length is longer than the predetermined length.

For a predetermined period of time from the time when the sound outputting part 150 starts playing the music after the character string detecting part 140 detects that the registered character string is contained in the voice acquired by the voice acquiring part 130, the character string detecting part 140 may stop detecting the registered character string. By this means, the music can be prevented from being frequently changed.

Further, when the voice acquiring part 130 acquires a plurality of voices at the same time, the character string detecting part 140 may detect the registered character string contained in the voice chosen based on characteristics of the acquired voices. For example, when Mr. A and Mr. B speak with voices which contain different registered character strings at the same time, the character string detecting part 140 detects the registered character string contained in the voice of Mr. A whose voice characteristics are similar to previously registered voice characteristics. The character string detecting part 140 may preferentially detect the registered character string contained in the voice of Mr. A when the character string detecting part 140 acquires the voices of a plurality of people including Mr. A at the same time, after the character string detecting part 140 detects the registered character string from the voice of Mr. A.

As described above, in the computer 100 executing the music playing program according to the present exemplary embodiment, the music is outputted after a predetermined delay time passes from the time when the voice acquiring part 130 acquires the voice containing the registered character string. Therefore, even when the period of time required for the character string detecting part 140 to detect the character string has variations, or the period of time required for the sound outputting part 150 to acquire the music has variations, the period of time from the time when the voice acquiring part 130 acquires the voice containing the registered character string to the time when the music is outputted does not vary. As a result, the user can correctly estimate the time from acquiring the voice to playing the music, and can make an effective presentation using the music.

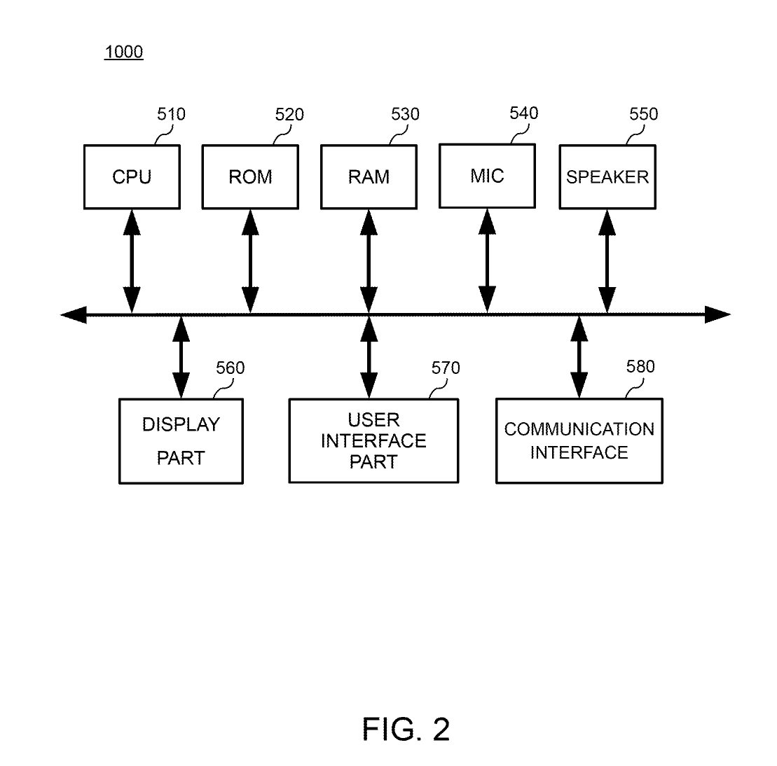

FIG. 2 shows the configuration of an information terminal 1000 as an example of the computer 100 executing the music playing program according to the first exemplary embodiment. The information terminal 1000 includes a CPU 510, a ROM 520, a RAM 530, a microphone 540, a speaker 550, a display part 560, a user interface part 570, and a communication interface 580. In the information terminal 1000, the CPU 510 reads the music playing program of the present disclosure stored in the ROM 520 and executes the program.

Specifically, the CPU 510 corresponds to the control part 110, and the ROM 520 and the RAM 530 correspond to the storage part 120. The microphone 540 corresponds to the voice acquiring part 130. The speaker 550 functions as the sound outputting part 150. The CPU 510 functions as the character string detecting part 140 by executing the music playing program.

The display part 560 is, for example, a liquid crystal display. The user interface part 570 is an interface which acquires an instruction of the user and is, for example, a touch panel placed on the display part 560. The communication interface 580 is connected to the network such as the Internet or a local area network (LAN). The CPU 510 transmits and receives data with another terminal which is connected through the network via the communication interface 580.

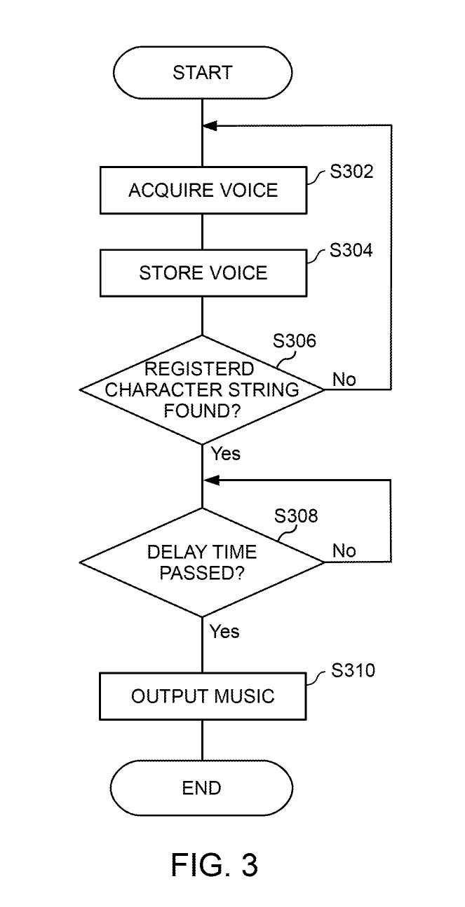

FIG. 3 shows an example of a flow chart of a music playing method according to the first exemplary embodiment. When the user speaks near the computer 100, the voice acquiring part 130 acquires the inputted voice (S302). The control part 110 converts the voice acquired by the voice acquiring part 130 into the digital signal and stores the signal in the storage part 120 with the time when the voice is acquired (S304). The control part 110 may store the voice in the storage part 120 for a period of time longer than the period of time required for the user to speak the longest registered character string among the registered character strings stored in the storage part 120. The control part 110 may delete the stored voice after the period of time required for the longest registered character string to be spoken has passed after storing the voice in the storage part 120.

The character string detecting part 140 determines if any one of a plurality of registered character strings previously stored in the storage part 120 is contained in the voice (S306). The control part 110 repeats the steps from S302 to S306 until the character string detecting part 140 detects the registered character string. When the registered character string is contained in the voice, the control part 110 waits from the time when the voice acquiring part 130 acquires the concerned voice to the time when the delay time which is previously stored in the storage part 120 passes (S308).

For example, when the period of time required for detecting that the registered character string is contained in the concerned voice from the time when the voice is acquired is T1, and the delay time is Td, the control part 110 waits for the period of time of Td−T1 after the registered character string is detected to be contained in the voice. The control part 110 may acquire the music data during a waiting time if it takes a while to acquire the music data to be played. The period of time Td−T1 is preferred to be longer than the period of time required for acquiring the music data. After the waiting time has passed, the control part 110 makes the sound outputting part 150 output the music corresponding to the registered character string detected by the character string detecting part 140 (S310). Here, the music data is the data required for playing the music and contains, for example, score information or acoustic signal information of the music.

The computer 100 may store a plurality of delay times corresponding to the plurality of registered character strings in the storage part 120. The computer 100 may previously store the delay time in the storage part 120, or acquire the delay times corresponding to the plurality of character strings from the user and store them in the storage part 120. By previously setting the delay time which varies with the registered character string, the user can play the music at a timing suitable for the content of the registered character string inputted by voice and the music to be played.

For example, if the storage part 120 previously stores a delay time of two seconds in association with “happy birthday,” the computer 100 plays the music two seconds after the user speaks a phrase “happy birthday.” If the storage part 120 previously stores a delay time of 0.5 seconds in association with the registered character string “let's do our best today as well,” the computer 100 plays the music 0.5 seconds after the user speaks the phrase “let's do our best today as well.” As described above, if the user knows in how many seconds the music will start to be played after the user speaks, the user can have a conversation or a presentation in accordance with the timing of the start of the music, and so the atmosphere of the place is livened up.

### [Registering a Character String and Music Data]

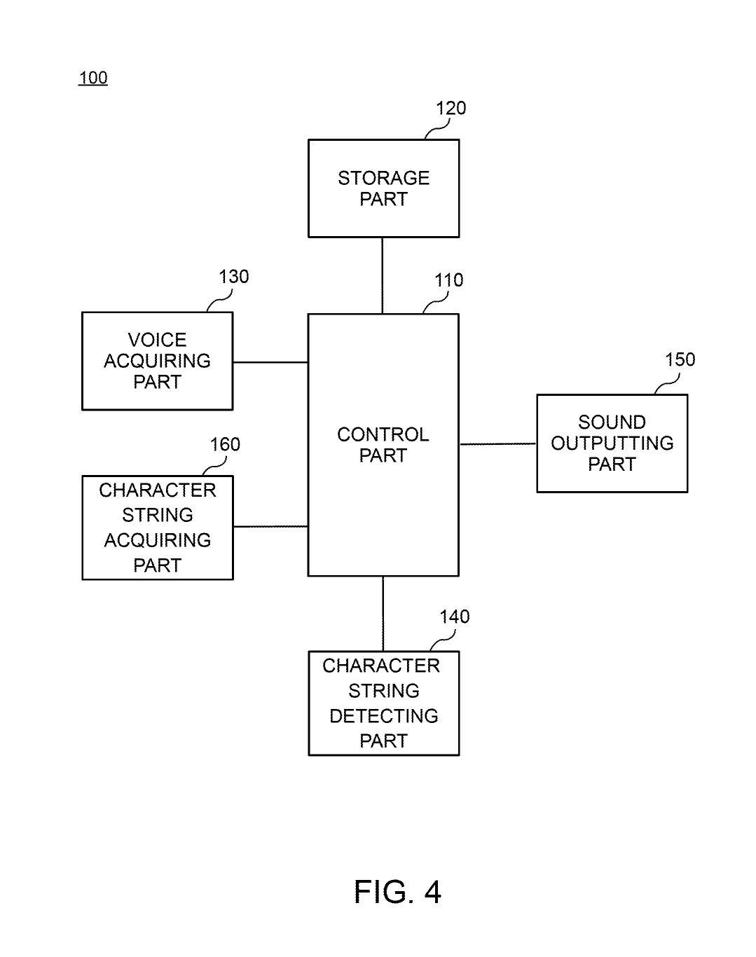

FIG. 4 shows another configuration example of the computer 100 executing the music playing method according to the present exemplary embodiment. The computer 100 shown in FIG. 4 is different from the computer 100 shown in FIG. 1 in a point that the computer 100 shown in FIG. 4 further includes a character string acquiring part 160.

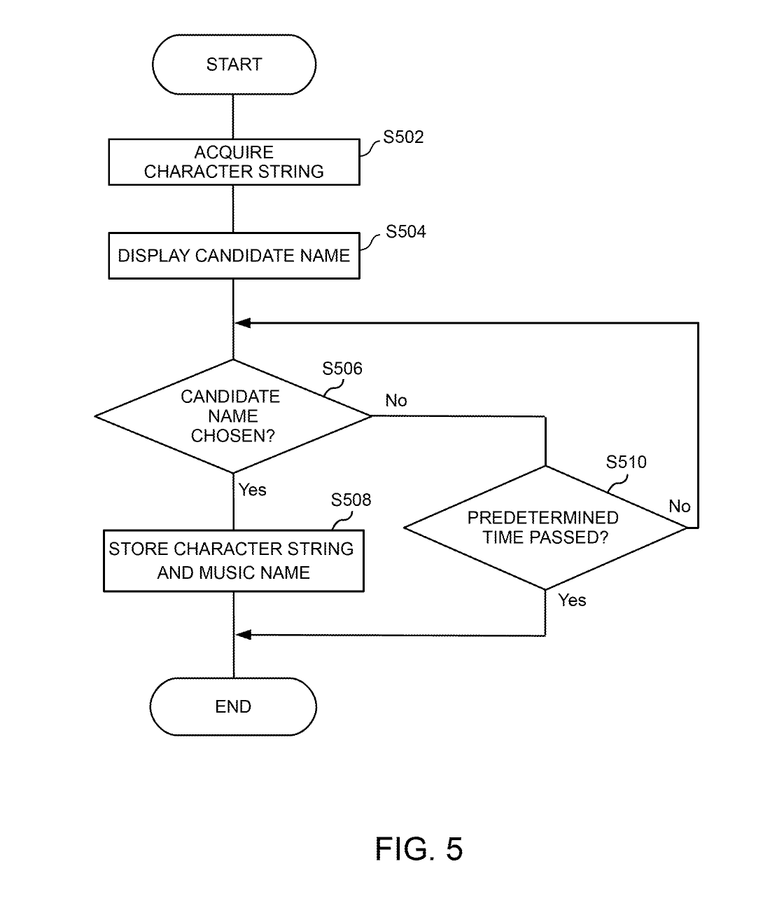

FIG. 5 shows an example of the flow chart of registering music in the music playing method according to the present exemplary embodiment. The character string acquiring part 160 acquires the registered character string inputted by the user (S502). The character string acquiring part 160 may acquire the character string via the user interface such as a touch panel and a keyboard, or acquire the character string converted from the inputted voice of the user by the character string detecting part 140.

When the character string acquiring part 160 acquires the registered character string in the character string acquiring step, the control part 110 displays a plurality of candidate names which shows candidates of the music names stored in association with the registered character string on the display part (S504). For example, the computer 100 displays names of the pieces of music which contain the registered character string in the lyrics. The computer 100 may display the candidates of the music names corresponding to the acquired registered character string by using a correspondence table that cross-references the plurality of character strings with the plurality of music names previously stored in the storage part 120. The computer 100 may transmit the registered character string acquired by the character string acquiring part 160 to the server which is connected thorough the network, and display the candidates of music name acquired from the server.

Next, when the music name is chosen by the user (S506), the control part 110 stores the music name corresponding to the candidate name chosen from among the plurality of candidate names in the storage part 120 in association with the registered character string (S508). The control part 110 may store the music data corresponding to the music name in the storage part 120 in association with the registered character string. If the music name is not chosen by the user within a predetermined period of time, the music registering ends (S510).

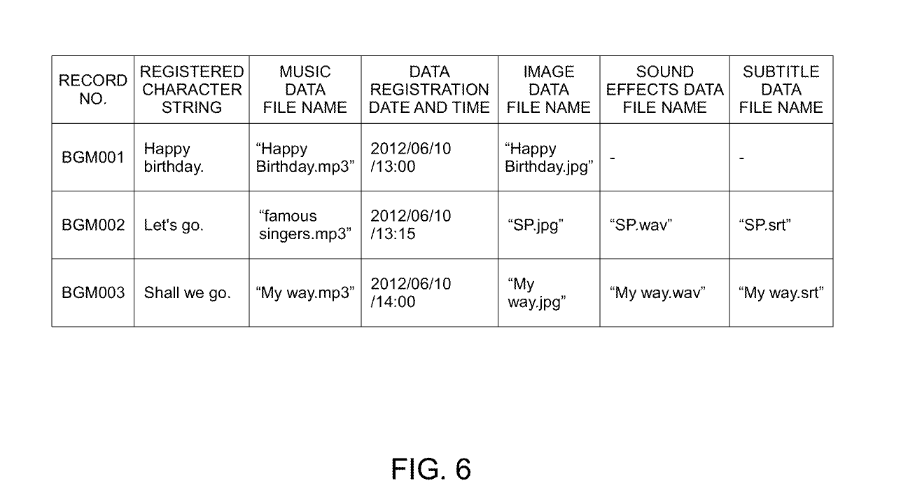

Here, a group of pieces of data which contains the registered character string and the music name stored in the music registering step is referred to as a “music data package” herein. FIG. 6 shows an example of the music data package. The music data package includes at least one of the registered character string, a music data file, a registration date and time of the music data package, an image data file, a sound effects file, and a subtitle data file. The music data package may contain information showing the delay time associated with the registered character string.

The storage part 120 may store a plurality of music data packages. When the character string acquiring part 160 acquires a registered character string, the control part 110 may play the music corresponding to the registered character string as well as image data or subtitle data in the music data package which contains the music after the delay time corresponding to the registered character string passes from the time when the voice containing the registered character string is acquired.

The control part 110 may update or delete contents of the music data package stored in the storage part 120 according to an instruction of the user. The storage part 120 stores the music data package in association with unique identification information of the user, and the control part 110 may authorize only the music data package corresponding to the identification information acquired from the user to be updated or deleted.

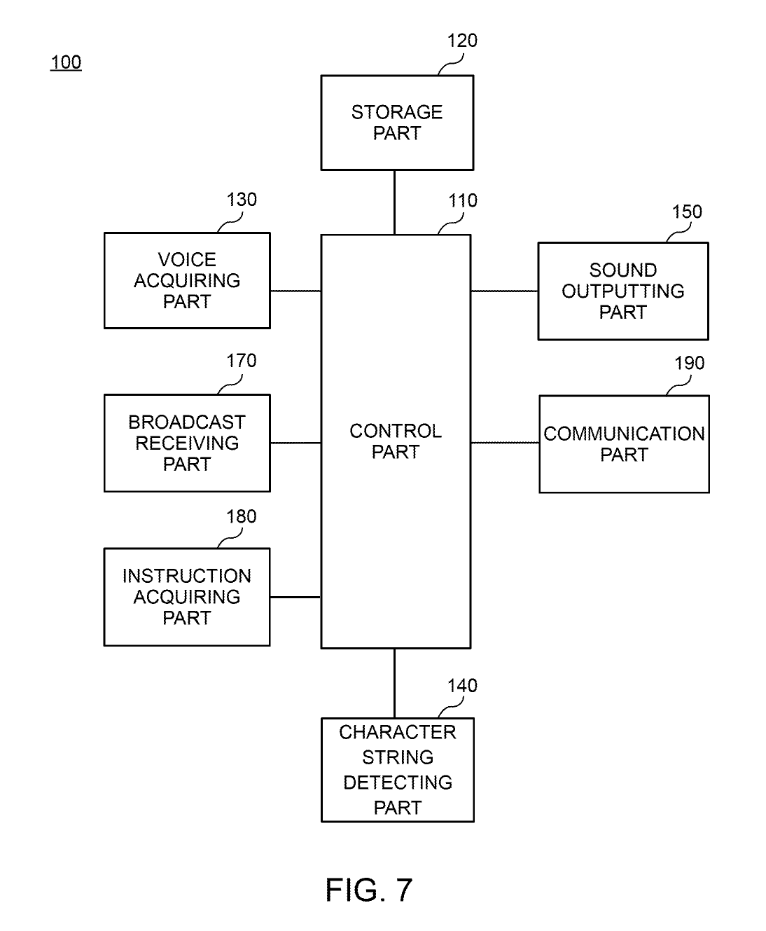

The control part 110 may retrieve the music data package corresponding to the character string inputted by the user and display the music data package corresponding to the character string. The user can see the displayed music data package and delete unwanted music data packages.

[Registering the Music Used in a Broadcast Program while the Program is Watched]
FIG. 7 shows another configuration example of the computer 100 executing the music playing method according to the present exemplary embodiment. The computer 100 shown in FIG. 7 is different from the computer 100 shown in FIG. 1 in a point that the computer 100 shown in FIG. 7 further includes a broadcast receiving part 170, an instruction acquiring part 180, and a communication part 190. When the user finds a music he likes while watching a broadcast program such as a digital broadcast or a program which can be watched by using a mobile terminal, the computer 100 according to the present exemplary embodiment can register the music data in the memory.

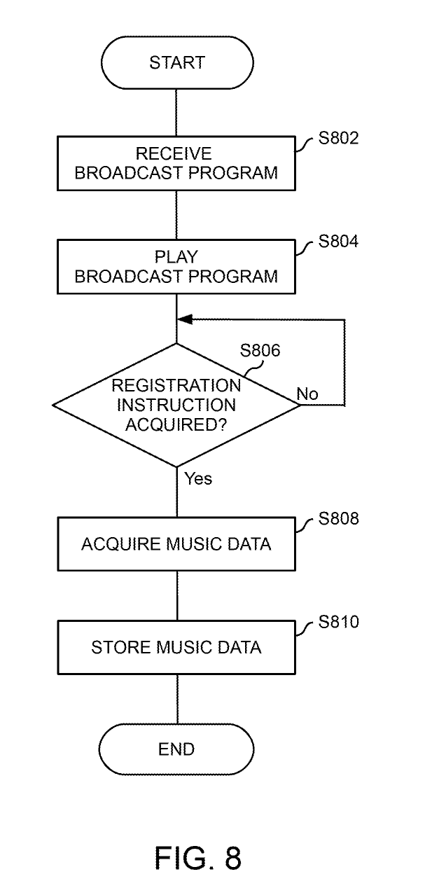

FIG. 8 shows an example of the flow chart of registering music in the music playing method according to the present exemplary embodiment. First, according to the user's instruction, the control part 110 receives the broadcast program via the broadcast receiving part 170 through the network such as the Internet and the LAN (S802) and plays the received broadcast program (S804).

Next, according to a registration instruction of the user received while playing the broadcast program (S806), the control part 110 acquires the music data contained in the broadcast program which is played when the instruction is received (S808). Then, the control part 110 stores the music data acquired in the music data acquiring step in the storage part 120 (S810). The control part 110 may display a registered character string candidate corresponding to the music data, and store the music data in the storage part 120 in association with the registered character string chosen by the user. The control part 110 may acquire the music data with the same music name as the music data acquired from the broadcast program from the server which is connected through the network.

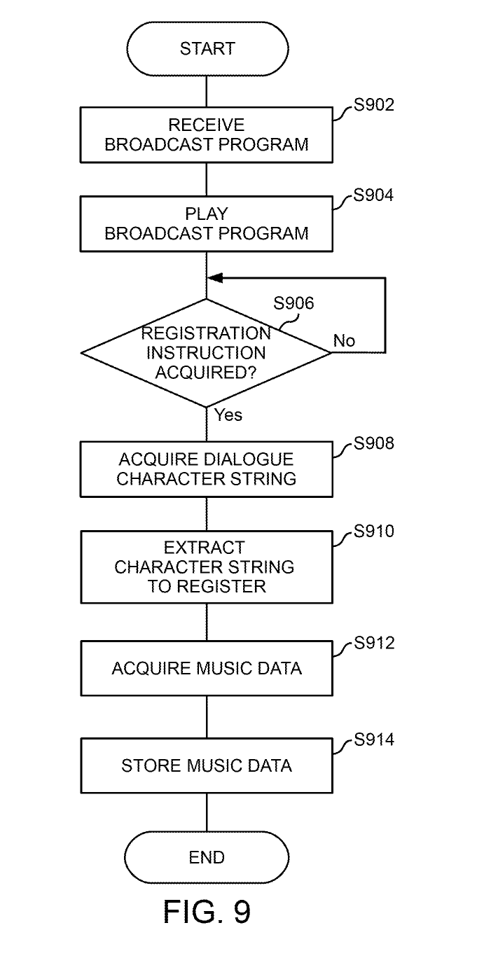

As described above, according to the music playing method of the present exemplary embodiment, the user can easily register the music used in the broadcast program while watching the program. Therefore, an environment to play the music that the user likes in response to the voice inputted by the user can be easily established.

[Acquiring and Storing Dialogue and Music Data from the Broadcast Program]
FIG. 9 shows another example of the flow chart of registering music according to the present exemplary embodiment. The step S908 and succeeding steps of the flow chart shown in FIG. 9 are different from the steps of the flow chart shown in FIG. 8. When the control part 110 receives the instruction to register the music data from the user who is watching the program (S906), the control part 110 requests program data through the communication part 190, and acquires a dialogue character string contained in the program that the user instructed to register (S908). For example, the control part 110 acquires the dialogue character strings broadcasted in a predetermined range of time from the time when the instruction was received. Here, the program data contains at least one of image data, text data such as the dialogue and the subtitles, and the music name data of the BGM used in the program.

The control part 110 may automatically extract at least a part of the dialogue character string as the registered character string (S910). For example, the control part 110 extracts a word contained in a word book previously stored in the storage part 120 as the registered character string from among the dialogue character strings. The control part 110 may transmit the information showing the reception time of the registration instruction to the server which is connected through the network, and acquire the dialogue character string from the concerned server.

Next, the control part 110 acquires the music data contained in the broadcast program which is played when the registration instruction is received in response to the registration instruction received while playing the broadcast program (S912). Further, the music data acquired in the step S912, the music data acquiring step, is stored in the storage part 120 in association with the registered character string extracted from the dialogue character string (S914).

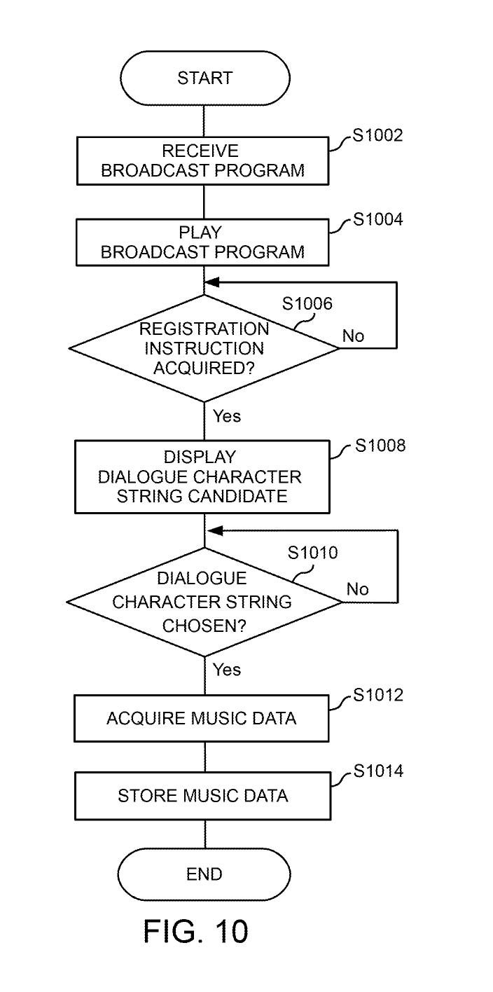

As described above, by acquiring the dialogue and music data from the broadcast program and storing them, the user can register the registered character string and the music data in association with each other without inputting a registered character string or downloading the music data from an external server.

[Storing the Music Data in Association with the Character String Chosen from the Acquired Dialogue]
FIG. 10 shows another example of the flow chart of registering music according to the present exemplary embodiment. The step S1008 and succeeding steps of the flow chart shown in FIG. 10 are different from the steps of the flow chart shown in FIG. 8. According to the music playing method of the present exemplary embodiment, the control part 110 displays the plurality of dialogue character strings acquired from the program the user is watching as the registered character string candidates, and stores the dialogue character string chosen by the user in the storage part 120 in association with the music data.

Specifically, when the control part 110 acquires the registration instruction in the step S1006, the control part 110 displays the plurality of dialogue character strings contained in the program which is played when the registration instruction from the user is received on the display part as the registered character string candidates (S1008). For example, the control part 110 displays the dialogue character string acquired in a predetermined range of time around the time when the registration instruction is acquired as the registered character string candidate. Next, when at least one of the plurality of displayed dialogue character strings is chosen (S1010), the instruction acquiring part 180 acquires the music data contained in the broadcast program which is being played when the registration instruction is received (S1012). The control part 110 stores the music data acquired in the step S1012, the music data acquiring step, in the storage part 120 in association with the dialogue character string chosen by the user as the registered character string (S1014).

As described above, because the control part 110 displays the plurality of dialogue character strings and stores the dialogue character string chosen by the user in the storage part 120 as the registered character string, it is not needed to store the unnecessary dialogue character strings. As a result, capacity of the storage part 120 is prevented from being increased, and the period of time required for the character string detecting part 140 to detect the registered character string can be reduced.

### [Registering the Dialogue and the Music Data Before the Registration Instruction is Received]

It is known that it takes a few seconds for a user to move his/her muscles to press the registration button after thinking that “I want to register it” according to the information captured by using his/her eyes or ears. For this reason, the control part 110 may acquire the dialogue character string and the music data contained in the broadcast program which is played at a time earlier by a time an average person takes from the time when he/she thinks that “I want to register it” and begins an operation of the registering instruction until he/she completes the operation of the registration instruction (hereinafter, referred to as “reaction time”), and store the dialogue character string and the music data in the storage part 120 in association with each other.

Specifically, the control part 110 keeps storing the broadcast program for a period of time longer than the above described reaction time. For example, the control part 110 stores the broadcast program in a ring buffer with a capacity which can store the broadcast program for the period of time longer than the above described reaction time.

When the instruction acquiring part 180 acquires the registration instruction from the user, the control part 110 searches the broadcast program stored in the storage part 120, and acquires the dialogue character string and the music data contained in the broadcast program which is played at a time earlier by a predetermined time than the time when the registration instruction is acquired (S1208). For example, the control part 110 acquires the dialogue character string and the music data contained in the broadcast program which is played at a time earlier by the time specified in the registration instruction.

### [A Communication Sequence]

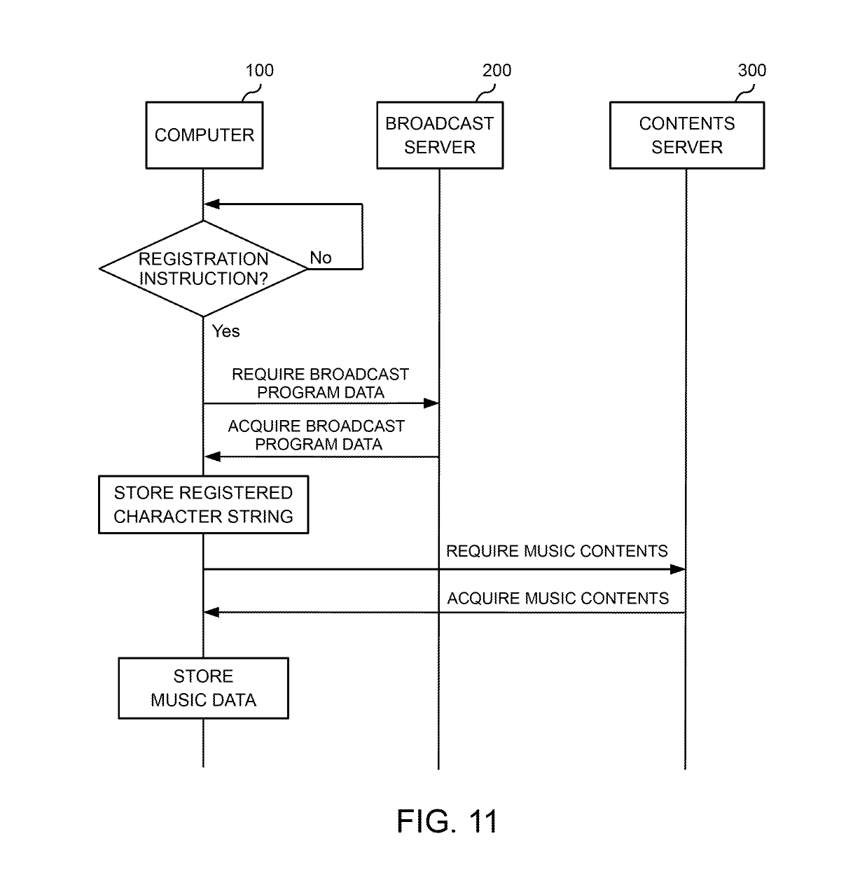

FIG. 11 is an example of the communication sequence for registering music according to the present exemplary embodiment. When the instruction acquiring part 180 acquires the instruction for registering the music data from the user, the control part 110 requests the program data from the broadcast server 200 through the network such as the Internet or the LAN. The broadcast server 200 transmits the program data to the computer 100 in response to the request.

When the computer 100 receives the program data from the broadcast server 200, the control part 110 stores the character string extracted from the dialogue character string contained in the program data in the storage part 120 as a registered character string. The control part 110 may store the registered character string and the music name in the storage part 120 in association with each other. The control part 110 may display a plurality of key words as the registered character string candidates, and may store the key word chosen by the user as the registered character string.

Next, the control part 110 requests music contents from the contents server 300 through the network such as the Internet and the LAN. The contents server 300 transmits the music contents to the communication part 190 in response to the request. When the computer 100 acquires the music contents, the computer 100 stores the music contents in the storage part 120 in association with the registered character string.

As described above, the music data corresponding to the inputted voice can be played without playing the broadcast program of which copyright is protected because the computer 100 acquires the music data from the contents server 300 which is different from the broadcast server 200 from which the broadcast data is acquired,

### The Second Exemplary Embodiment

### Music Playing in Cooperation with a Plurality of Information Terminals

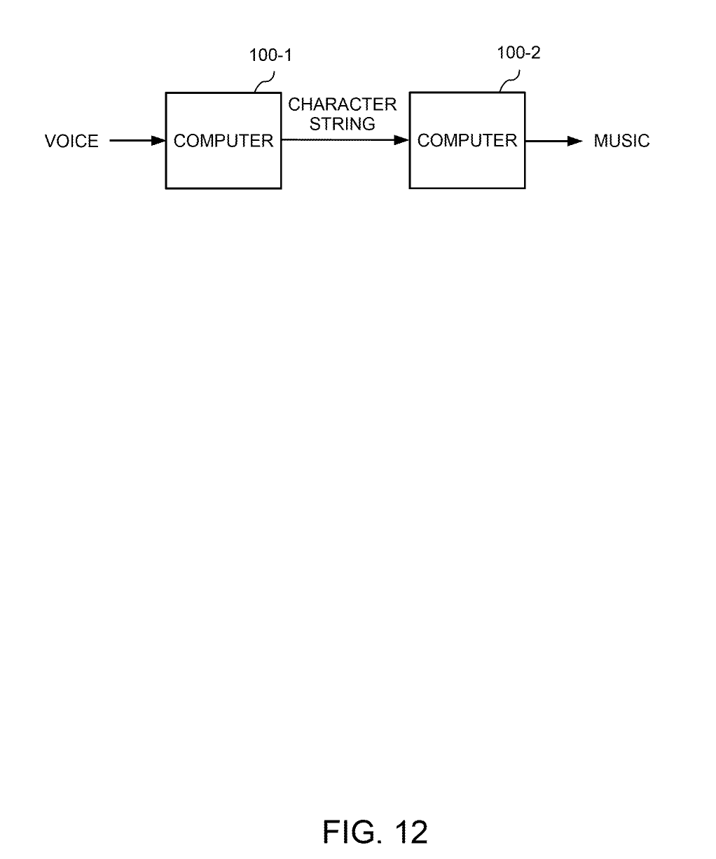

FIG. 12 shows the configuration of a music playing system which consists of a computer 100-1 and another computer 100-2 executing the music playing method according to the present exemplary embodiment. The computer 100-1 and the computer 100-2 play the music in cooperation with each other.

For example, when a voice is inputted to the computer 100-1, the character string detecting part 140 detects that the voice acquired by the voice acquiring part 130 contains the registered character string. Next, the registered character string detected by the character string detecting part 140 is transmitted from the communication part 190 to the computer 100-2 through the network such as the Internet and the LAN. When the computer 100-2 receives the registered character string from the computer 100-1, the computer 100-2 outputs the music corresponding to the registered character string contained in the music data package previously stored in the storage part 120.

Further, in the music playing system, the music may be played by a plurality of terminals at the same time by using a plurality of computers 100 with the music playing program of the present disclosure previously installed to the computers 100. For example, the computer 100-1 transmits the registered character string contained in the acquired voice and the information showing the time to play the music to the plurality of computers 100 all at once. The computer 100-1 may generate the information showing the time to play the music based on the delay time previously stored in the storage part 120. The plurality of computers 100 that receive the registered character string from the computer 100-1 simultaneously play the music at the specified time.

The plurality of computers 100 may play different parts of the same music according to their respective positions. For example, the respective computers 100 acquire position information by using the global positioning system (GPS) and the like. The computer 100 placed on the first area (for example, on the right side) of the computer 100-1 which transmits the registered character string may play the right side music of the stereo music, and the computer 100 placed on the second area (for example, on the left side) may play the left side music of the stereo music.

As described above, according to the present exemplary embodiment, by playing the music not with one information terminal but with the plurality of information terminals, the music can be heard even in a spacious venue. Further, by playing the stereo music by using the plurality of information terminals, more effective presentation can be made and the atmosphere of the place can be enlivened effectively.

### The Third Exemplary Embodiment

### The Music Playing System

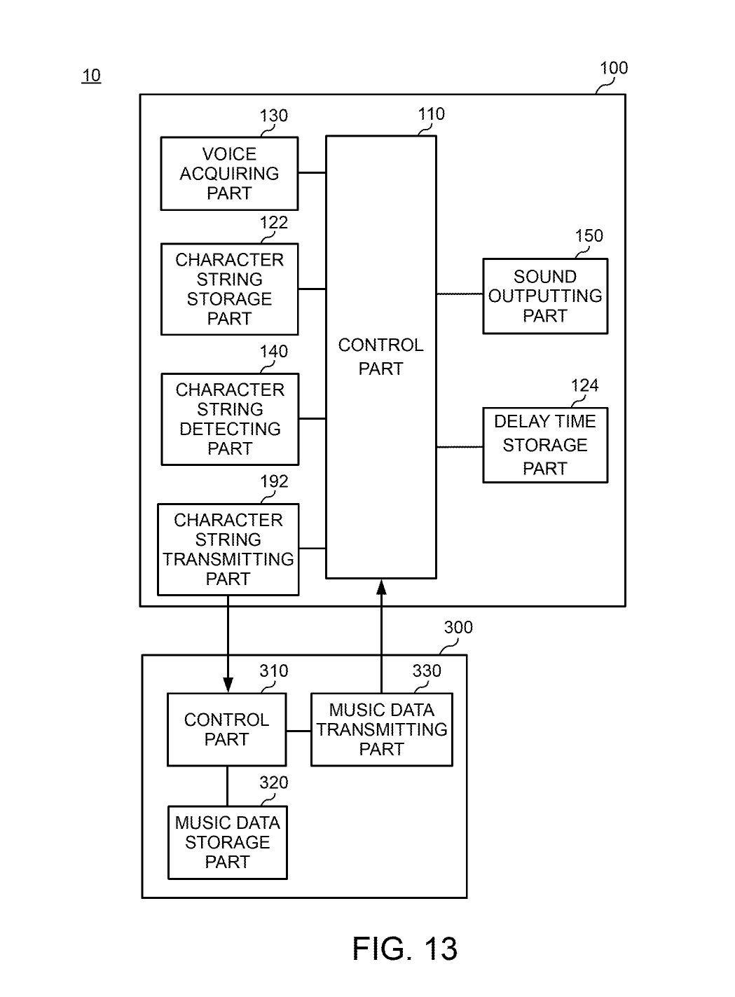

FIG. 13 shows the configuration of a music playing system 10 according to the third exemplary embodiment. The music playing system 10 includes the computer 100 and the contents server 300. The computer 100 is, for example, a mobile information terminal. The contents server 300 functions as a data managing apparatus, and transmits and receives the data with the computer 100. For example, the contents server 300 transmits the music data to the computer 100 according to the instruction from the computer 100.

The computer 100 may include the configuration described in the above embodiment, and execute the music playing method described in the above embodiment. For example, the computer 100 includes the control part 110, the voice acquiring part 130 which acquires the inputted voice, a character string storage part 122 which stores the plurality of registered character strings, the character string detecting part 140 which detects that any one of the plurality of registered character strings is contained in the voice, a character string transmitting part 192 which transmits the registered character string detected by the character string detecting part 140 to the contents server 300, a delay time storage part 124 which stores the information showing the delay time which is the period of time from the acquisition of the voice to the output of the music, and the sound outputting part 150 which outputs the music data after the delay time has passed after the acquisition of the voice.

The contents server 300 includes a control part 310, a music data storage part 320 which stores the plurality of registered character strings and the plurality of music data in association with each other, and a music data transmitting part 330 which transmits the music data corresponding to the registered character string received from the information terminal to the information terminal.

When the computer 100 detects the registered character string from the inputted voice, the computer 100 transmits the information showing the detected registered character string to the contents server 300. In the contents server 300, the control part 310 reads the music data corresponding to the received registered character string from the music data storage part 320, and transmits the music data to the computer 100 via the music data transmitting part 330. When the computer 100 receives the music data, the computer 100 plays the music after the predetermined delay time passes after the acquisition of the voice containing the registered character string.

The delay time storage part 124 may store the delay time obtained by adding, to the time when the control part 110 acquires the music data, (i) the delay time described in the above embodiment and (ii) the period of time from the time when the character string transmitting part 192 transmits the registered character string. By this means, the music can be played at the timing when the scheduled period of time has passed after the user speaks words regardless of the period of time required for acquiring the music data from the contents server 300.

The present disclosure is described with the exemplary embodiments but the technical scope of the present disclosure is not limited to the scope described in the above embodiment. It is apparent for those skilled in the art that it is possible to make various changes and modifications to the embodiment. It is apparent from the description of the scope of the claims that the forms added with such changes and modifications are included in the technical scope of the present disclosure.

It should be noted that execution order of each process of means shown in claims, specification, and drawings is not clearly indicated with the words such as “before” and “in advance,” and unless an output of a previous process is used in a later process, the process may be performed in any order. Regarding an action flow in the claims and specification, even when described using “first,” “next” or the like, it does not mean that it is essential to be performed in the order.

What is claimed is:

1. A music playing method for playing music using a computer, the method comprising: acquiring an inputted voice;
detecting that any one of a plurality of registered character strings stored in a memory is contained in the voice; and
outputting music corresponding to the registered character string after a delay time stored in the memory has passed from the time when the voice containing the registered character string detected in the detecting is acquired.

2. The music playing method according to claim 1, further comprising:
storing the delay time in the memory in association with the registered character string before the acquiring of the voice, wherein
the outputting of the music includes outputting the music corresponding to the registered character string after the delay time associated with the registered character string has passed.

3. The music playing method according to claim 1, wherein
the outputting of the music includes outputting the music after the delay time has passed from the time of acquiring the voice in which the registered character string is detected, the delay time being longer than the maximum period of time required for detecting the registered character string.

4. The music playing method according to claim 3, wherein
the outputting of the music includes outputting the music after the delay time has passed from the time of the acquiring of the voice in which the registered character string is detected, the delay time being longer than the sum of the maximum period of time required for detecting the registered character string and the maximum period of time for preparing the music corresponding to the registered character string to be played.

5. The music playing method according to claim 1, wherein
the detecting includes stopping detecting the registered character string for a predetermined period of time after detecting that the registered character string is contained in the voice.

6. The music playing method according to claim 1, further comprising, before the detecting:
acquiring the inputted registered character string;
displaying a plurality of candidate names showing candidates of music names stored in association with the registered character strings when the registered character string is acquired; and
storing the music name corresponding to the candidate name chosen from among the plurality of candidate names in association with the registered character string.

7. The music playing method according to claim 1, further comprising:
receiving a broadcast program;
playing the broadcast program;
acquiring the music data contained in the broadcast program which is played when a registration instruction is received in response to the registration instruction received while the broadcast program is played; and
storing the music data acquired in the acquiring in a memory, wherein
the outputting outputs music based on the music data stored in the memory.

8. The music playing method according to claim 7, wherein
the acquiring of the music data includes acquiring a dialogue character string contained in the broadcast program, and
the storing of the music data includes storing at least a part of the dialogue character string as the registered character string in association with the music data.

9. The music playing method according to claim 8, wherein
the acquiring of the music data includes displaying a plurality of acquired dialogue character strings, and
the storing of the music data includes storing the dialogue character string chosen from the plurality of displayed dialogue character strings as the registered character string in association with a music name.

10. The music playing method according to claim 8, wherein
the storing of the music data includes storing the dialogue character string and a music name in association with each other, the dialogue character string being contained in the broadcast program which is played at a time earlier by a predetermined time than the time when the registration instruction is acquired.

11. The music playing method according to claim 10, wherein
the storing of the music data includes storing the dialogue character string and the music name in association with each other, the dialogue character string being contained in the broadcast program which is played at a time earlier by a time required for an average person to complete an operation for the registration instruction after beginning the operation.

12. The music playing method according to claim 1, further comprising:
transmitting the registered character string from a first computer to a second computer; and
outputting the music corresponding to the registered character string received from the first computer from the second computer.

13. The music playing method according to claim 12, further comprising:
transmitting information showing the time to play the music from the first computer to the second computer; and
outputting the music from the first computer and the second computer at the same time.

14. The music playing method according to claim 12, further comprising:
acquiring position information showing a position of the first computer and a position of the second computer; and
outputting music from the first computer and other music from the second computer according to the position of the first computer and the position of the second computer.

15. A music playing system for playing music comprising:
a computer; and
a data managing apparatus configured to transmit and receive data to and from the computer, wherein
the computer includes:
a voice acquiring part configured to acquire an inputted voice;
a character string storage part configured to store a plurality of registered character strings;
a character string detecting part configured to detect that any one of the plurality of registered character strings is contained in the voice; and
a character string transmitting part configured to transmit the registered character string detected by the character string detecting part to the data managing apparatus,
the data managing apparatus includes:
a music data storage part configured to store the plurality of registered character strings and a plurality of pieces of music data in association with each other; and
a music data transmitting part configured to transmit the music data corresponding to the registered character string received from the computer to the computer, and
the computer further includes:
a delay time storage part configured to store information showing the delay time from the time when the voice is acquired to the time when music based on the music data is outputted; and
an outputting part configured to output the music after the delay time has passed from the time when the voice is acquired.

16. The music playing system according to claim 15, wherein
the delay time storage part stores the delay time in a memory in association with the registered character string, and
the outputting part outputs the music corresponding to the registered character string after the delay time corresponding to the registered character string has passed.

17. The music playing system according to claim 15, wherein
the outputting part outputs the music after the delay time has passed from the time of acquiring the voice in which the registered character string is detected, the delay time being longer than the maximum period of time required for detecting the registered character string.

18. A recording medium storing a music playing program that causes a computer to perform:
acquiring the inputted voice;
detecting that any one of the plurality of registered character strings stored in a memory is contained in the voice; and
outputting music corresponding to the registered character string after a delay time stored in the memory has passed from the time when the voice containing the registered character string detected in the detecting is acquired.

19. The recording medium storing the music playing program according to claim 18, further comprising:
storing the delay time in the memory in association with the registered character string before the acquiring of the voice, wherein
the outputting the music includes outputting the music corresponding to the registered character string after the delay time associated with the registered character string has passed.

20. The recording medium storing the music playing program according to claim 18, wherein
the outputting music includes outputting the music after the delay time has passed from the time of acquiring the voice in which the registered character string is detected, the delay time being longer than the maximum period of time required for detecting the registered character string.
